(19) United States
(12) Patent Application Publication
(10) Pub. No.: US 2025/0225540 A1
(43) Pub. Date: Jul. 10, 2025

(54) SYSTEM AND METHOD FOR ANALYZING DATA SETS USING INDEXING

(71) Applicant: Fiserv, Inc., Milwaukee, WI (US)

(72) Inventors: Frank J. Bisignano, Watchung, NJ (US); Guy Chiarello, Allentown, NJ (US); Prasanna Gopal Dhore, Duluth, GA (US); Daniel Parzych, Milton, GA (US); Muthukumar Aruvankulam Palani, Rockville, MD (US); Meeta Gulati, The Hague (NL); Tien Thi Cam Nguyen, San Jose, CA (US); Sanjay Mathan, Marietta, GA (US); Vrajesh Kotta, Ashburn, VA (US); Jerome Michael Spriggs, Katy, TX (US)

(73) Assignee: Fiserv, Inc., Milwaukee, WI (US)

(21) Appl. No.: 19/012,539

(22) Filed: Jan. 7, 2025

Related U.S. Application Data
(60) Provisional application No. 63/618,526, filed on Jan. 8, 2024.

(51) Int. Cl. G06Q 30/0204; G06N 3/09

(52) U.S. Cl. CPC G06Q 30/0204; G06N 3/09

(57) ABSTRACT

A method may include obtaining merchant data for a plurality of merchants, adjusting the merchant data to obtain adjusted data based upon a ratio of data types in the merchant data, performing a first filtering operation on the plurality of merchants for identifying a first subset of small business merchants from the plurality of merchants, performing a second filtering operation on the first subset of small business merchants for identifying a second subset of small business merchants, applying one or more rules to the adjusted data of the second subset of small business merchants associated with a pre-determined criteria to obtain processed data for the second subset of small business merchants, calculating an index value for the second subset of small business merchants, and generating a report analyzing a trend based on the index value, the report comprising additional information for the second subset of small business merchants.

### CROSS-REFERENCE TO RELATED APPLICATIONS

This application claims priority to U.S. Provisional Application No. 63/618,526, filed Jan. 8, 2024, which application is incorporated by reference herein in its entirety.

### BACKGROUND

Analysis of data sets may provide desired key indicators or trends indicative of various performance or other condition parameters of an entity (e.g., a small business). However, such analysis can be difficult, time-consuming, and reliant upon questionable data. For example, survey results for gauging economic strength of a sector or geography may result in significant delays and inaccuracies. Delayed generation of the key indicators can render difficult the task of determining current circumstances and predicting future outcomes.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure relate to a method including obtaining merchant data for a plurality of merchants, adjusting the merchant data to obtain adjusted data based upon a ratio of data types in the merchant data, performing a first filtering operation on the plurality of merchants based on the adjusted data for identifying a first subset of small business merchants from the plurality of merchants, performing a second filtering operation on the first subset of small business merchants for identifying a second subset of small business merchants from the first subset of small business merchants, wherein the second filtering operation is based at least upon a volume of transactions of the small business merchants, applying one or more rules to the adjusted data of the second subset of small business merchants associated with a pre-determined criteria to obtain processed data for the second subset of small business merchants, calculating an index value for the second subset of small business merchants, wherein the index is calculated as a function of the processed data of the second subset of small business merchants and a historical baseline, and generating a report analyzing a trend based on the index value, the report comprising additional information for the second subset of small business merchants.

Aspects of the present disclosure relate to a system including one or more memories having computer-readable instructions stored thereon and one or more processors that execute the computer-readable instructions to: obtain merchant data for a plurality of merchants, adjust the merchant data to obtain adjusted data based upon a ratio of data types in the merchant data, perform a first filtering operation on the plurality of merchants based on the adjusted data for identifying a first subset of small business merchants from the plurality of merchants, perform a second filtering operation on the first subset of small business merchants for identifying a second subset of small business merchants from the first subset of small business merchants, wherein the second filtering operation is based at least upon a volume of transactions of the small business merchants, apply one or more rules to the adjusted data of the second subset of small business merchants associated with a pre-determined criteria to obtain processed data for the second subset of small business merchants, calculate an index value for the second subset of small business merchants, wherein the index is calculated as a function of the processed data of the second subset of small business merchants and a historical baseline, and generate a report analyzing a trend based on the index value, the report comprising additional information for the second subset of small business merchants.

Aspects of the present disclosure relate to a computer-implemented method of training a neural network for generating economic forecast data structures including collecting a first set of index values and economic data, creating a first training set for a first stage of training comprising the collected first set of index values and the collected economic data, training the neural network in the first stage of training using the first training set, executing the neural network using as input a second set of index values to generate an economic data forecast data structure including forecasted economic data, creating a second training set for a second stage of training comprising the first training set and a subset of the forecasted economic data selected based on a loss calculated using a difference between the subset of the forecasted economic data and measured economic data, and training the neural network in the second stage of training using the second training set.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of a computing system for computing an index and using the index for various reporting actions.

FIG. 2A is an example flow diagram illustrating a method for generating a report including an index.

FIG. 2B is an example flow diagram illustrating a continuation of the method of FIG. 2A.

FIG. 3 is an example flow diagram illustrating an example of generating a report including an index.

FIG. 4 is an example flow diagram illustrating a method for generating a small business index report.

FIG. 5 is an example block diagram of a computing system.

FIG. 6 is an example flow diagram illustrating a method for training a neural network to generate economic forecast data structures.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to computing index values indicative of trends of parameters or changes over a baseline and using the computed indices for automatically generating reports mapping the trends. For example, the index values can correspond to trends of percentage changes over a baseline for small business revenue. Data on small business revenue is crucial for monitoring macroeconomic conditions but is often underrepresented in economic data. In the United States, personal consumption expenditures represent nearly 70% of gross domestic product (GDP) and are therefore a key determinant of the cyclical position of the economy. However, consumption, of which small businesses provide a significant percentage, can be hard to measure in practice, particularly in a timely and detailed manner. Existing official statistics on consumer spending are extremely useful but limited in scope, accuracy, and timeliness. Often, statistics are available only with significant latency, reducing their usefulness. By automatically generating reports based on live data, embodiments discussed herein provide accurate and timely data regarding small businesses, providing key insights with low latency.

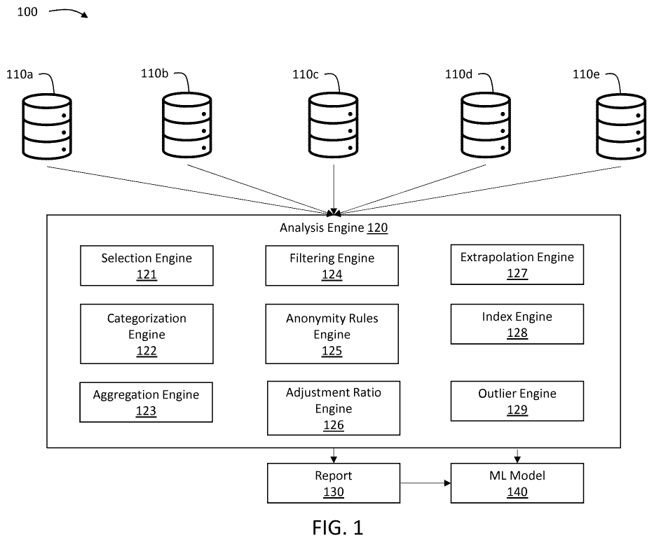

FIG. 1 is an example block diagram of a computing system 100 for computing an index. The computing system 100 may include databases 110a, 110b, 110c, 110d, and 110e, referred to herein collectively as databases 110. Although five databases are illustrated, the databases 110 may include more or fewer than five databases. The databases 110 may be configured to store merchant data (i.e., transaction information, data describing transactions, merchant location, merchant name, merchant type). In some implementations, the databases 110 may each include merchant data from a separate source and/or data of a different type. In some implementations, each database of the databases 110 includes data of a same data type from different sources (e.g., different merchants). In an example, each of the databases 110 includes credit card transactions and/or cash transactions from different merchants. In some implementations, each database of the databases 110 may include data from a same source of different data types. In an example, each database of the databases 110 includes different transactions from a single merchant. In an example, each database of the databases 110 includes transactions from merchants in different geographic regions.

In some implementations, at least one of the databases 110 includes economic data, such as census data. The economic data can be compiled from multiple different sources or databases. The economic data can be used to modify or adjust index values, as discussed herein.

The merchant data may include historical transactions. In an example, the historical transactions include monthly transactions. In an example, the databases 110 may include transactions obtained by a payment processor, such as an issuing processor. The term “transactions” may refer to financial transactions, including card payments, automated clearing house (ACH) transfers, checks, wire transfers, cash transactions, and other exchanges. In an example, a transaction is a credit card payment at a merchant for goods or services. The transactions may each include an amount, a description, a location, a merchant, and/or a merchant category code (MCC). While various examples discussed herein relate to transactions, the present disclosure applies to categorization of data other than transactions. Thus, the databases 110 may include any kind of merchant data, including credit and debit receipts.

At least some of the transactions may be categorized. The transactions may be categorized using a standardized set of category codes. In an example, the transactions are categorized using the merchant category codes (MCCs). Each merchant may be associated with one or more MCCs such that transactions are categorized according to the merchant's MCCs. In an example, a merchant which sells baked goods may be associated with MCC 5462 for “Bakeries.” In an example, a merchant which sells baked goods and candy may be associated with MCC 5462 for “Bakeries” and MCC 5441 for “Candy, Nut, and Confectionary Stores.”

The computing system 100 includes an analysis engine 120. The analysis engine 120 may obtain the merchant data from the databases 110. The analysis engine 120 may generate a report 130 based on an index computed based on the merchant data from the databases 110. In some implementations, the analysis engine 120 may calculate the index for the report 130 based on monthly merchant data. In some implementations, the analysis engine 120 may calculate the index for the report 130 within the first five days of a month based on merchant data of a prior month immediately preceding the month. In some implementations, the analysis engine 120 may calculate the index for the report within the first three days of a month based on merchant data of a prior month immediately preceding the month. In some implementations, the analysis engine 120 may calculate the index for the report within the first day of a month based on merchant data of a prior month immediately preceding the month. The merchant data may include hundreds of thousands of transactions, requiring a specialized system, such as the analysis engine 120 for calculate the index for the report within the first five days, three days, or day of the month.

The analysis engine 120 may include a selection engine 121. The selection engine 121 may select merchants whose merchant data is to be used in generating the report 130. The selection engine 121 may select the merchants based on geography, merchant type, and/or merchant size. In an example, the selection engine 121 may select US merchants, California merchants, small business merchants, construction material merchants, and/or small business construction material merchants. The selection engine 121 may select merchants of any type and/or in any geography.

The analysis engine 120 may calculate monthly sales for the merchants. The analysis engine 120 may calculate monthly sales for the merchants selected by the selection engine 121 and/or for all merchants for which the analysis engine 120 obtains merchant data. In an example, the analysis engine 120 calculates monthly sales data for all merchants and then the selection engine 121 selects merchants based on their monthly sales data (e.g., selects small businesses). In an example, the selection engine 121 selects merchants and then the analysis engine 120 calculates monthly sales data for the selected merchants. In some implementations, the selection engine 121 selects the merchants based on additional factors, such as adjusted monthly sales, annual sales, or estimated annual sales based on the adjusted monthly sales, as discussed herein. In an example, the selection engine 121 selects merchants according to Small Business Administration (SBA) criteria for small businesses. A small business may be a manufacturing company with 500 employees or fewer or a non-manufacturing business with average annual receipts under $7.5 million. Criteria defining small businesses may vary based on North American Industry Classification System (NAICS) categories. The selection engine 121 may select small business merchants based on the monthly sales data and the small business criteria for the relevant NAICS category. In an example, the annual average receipts for a small business for NAICS “111110” for “Soybean Farming” may be $2.25 million, while the annual average receipts for a small business for NAICS “512240” for “Sound Recording Studios” may be $11 million. Additional criteria for small businesses may include number of employees.

The analysis engine 120 may include a categorization engine 122. In some implementations, the categorization engine 122 may categorize the merchants. In some implementations, the categorization engine 122 may categorize the selected merchants. The categorization engine 122 may categorize the merchants based on characteristics of the selected merchants. In an example, the categorization engine 122 may categorize the merchants into NAICS codes based on MCCs associated with the merchants. The merchants may select the MCCs for their products, while NAICS codes are generally used to categorize merchants by industry. The categorization engine 122 may categorize the merchants into NAICS codes based on a predetermined mapping of MCCs to NAICS codes.

The analysis engine 120 may include an aggregation engine 123. The aggregation engine 123 may aggregate multiple merchants of the merchants or selected merchants based on common factors. Multiple merchants may in fact represent a single merchant entity. In an example, different point of sale devices and/or different segments of a merchant may appear to be different merchants. The aggregation engine 123 may identify multiple merchants corresponding to a single merchant and aggregate the multiple merchants as the single merchant. In some implementations, the aggregation engine 123 identifies multiple merchant IDs each sharing a same NAICS, a same Tax ID, and/or a same location (e.g., same longitude and latitude up to six decimal places) and aggregates the multiple merchant IDs to a single merchant key. Further processing of the merchant data is performed using the merchant key which aggregates the multiple merchant IDs.

The analysis engine 120 may include a filtering engine 124. The filtering engine 124 may remove merchants and their corresponding data from the merchant data. The filtering engine 124 may compare the merchants to predetermined criteria to remove merchants that do not correspond to the predetermined criteria. In an example, the filtering engine 124 removes merchants that are not small businesses. In an example, the filtering engine 124 removes merchants that have a sales volume below a predetermined threshold, such as $20. In an example, the filtering engine 124 removes merchants that have a sales volume that is increasing above a predetermined rate of increase threshold. In this way, the filtering engine 124 may remove merchants that do not accurately reflect small businesses.

The analysis engine 120 may include an anonymity rules engine 125. The anonymity rules engine 125 may apply predetermined rules to the merchant data to preserver merchant anonymity. In some implementations, the anonymity rules engine 125 determines whether groupings of merchants, otherwise referred to as strata, each contain at least five merchants and whether a single merchant contributes more than 25% to a data point for the grouping of merchants. The anonymity rules engine 125 may remove or nullify any data point in the report 130 that does not comply with this requirement. In an example, the anonymity rules engine 125 determines whether a NAICS category in a state has a sales data point based on at least five merchants where no single merchant contributes more than 25% to the sales data point. In this example, the anonymity rules engine 125 may remove the sales data point from the report 130 if the sales data point is based on less than five merchants or if a single merchant contributes more than 25% to the sales data point.

In some implementations, the anonymity rules engine 125 may compare groupings of merchants, or strata, to a population stability index (PSI) threshold. A PSI may be a measure of a stability of a stratum. The PSI may be calculated using Expression 1:

$$PSI = ( A - B ) * ln ( \frac{A}{B} ) \qquad Expression 1$$

In Expression 1, A represents the previous time period's raw stratum sales divided by the previous time period's overall raw sales and B represents the current time period's raw stratum sales divided by the previous time period's overall raw sales. In some implementations, anonymity rules engine 125 calculates the PSI for a stratum and compares the stratum PSI to the PSI threshold. In an example, the PSI threshold is 0.2. The time period may be a month, three months, four months, or a year. In some implementations, the anonymity rules engine 125 compares the monthly PSI to the PSI threshold and, in response to the monthly PSI being higher than the PSI threshold, the anonymity rules engine 125 compares the yearly PSI to the PSI threshold. If a stratum exceeds the PSI threshold for both its monthly and yearly PSI, the strata may be flagged for analysis and correction. In an example, the anonymity rules engine 125 removes the stratum from the report 130 based on the stratum's monthly and yearly PSIs exceeding the PSI threshold. In an example, the anonymity rules engine 125 marks the stratum in the report 130 to indicate that the stratum's monthly and yearly PSIs exceed the PSI threshold.

In some implementations, the anonymity rules engine 125 determines whether there are missing historical values for a stratum. In an example, the anonymity rules engine 125 determines whether there are missing historical values for the stratum and marks the stratum in the report 130 to indicate that the stratum includes missing historical values.

In some implementations, the anonymity rules engine 125 compares a stratum to a minimum number of merchants for the stratum such that a data point associated with the stratum has a predetermined confidence interval and a predetermined margin of error. In an example, the anonymity rules engine 125 determines whether the data point associated with the stratum has a confidence interval of 90% and a margin of error of 10%. The minimum number of merchants, or minimum sample size, may be calculated using Expression 2:

$$Sample size ( n ) = \frac{\frac{{z}^{2} * p * ( 1 - p )}{{e}^{2}}}{1 + \frac{{z}^{2} * p * ( 1 - p )}{{e}^{2} * N}} \qquad Expression 2$$

In Expression 2, z corresponds to z-score values for the corresponding confidence interval (e.g., 90%), p corresponds to a population proportion, e corresponds to a margin of error, or level of required precision (e.g., 10%), N corresponds to a population size, and n corresponds to a sample size. If the merchant count for a stratum is less than the minimum sample size n, the anonymity rules engine 125 may remove the stratum from the report 130 or mark the stratum as not having a sufficiently large sample size.

In some implementations, the anonymity rules engine 125 may identify strata for capping. Capping a stratum may include adjusting its corresponding data point in the report 130 based on a cap value. In some implementations, the anonymity rules engine 125 may, in response to a stratum violating any of the anonymity rules discussed herein (i.e., at least five merchants in a stratum with no one merchant contributing more than 25%, PSI threshold, null historical values, minimum population size for confidence interval) and contributing more than 10% of a data point for a geographic region, determine that the stratum should be capped. In an example, the anonymity rules engine 125 may determine that a NAICS stratum violates one of the anonymity rules and contributes more than 10% of sales for the state of Wyoming, meaning that the NAICS stratum should be capped for Wyoming. Strata may be capped for state sales based on Expression 3:

$$V = S * ( N + 2 * S T D ) \qquad Expression 3$$

In Expression 3, V corresponds to the corrected sales, S corresponds to the state extrapolated sales, N corresponds to the National NAICS extrapolated sales contribution, and STD corresponds to a standard deviation of N from its average over the last twelve months.

In a fictitious example, the stratum of NAICS721 in Texas in April 2023 violates the five merchants and 25% rule and has $50k in extrapolated sales. In April 2023, the state of Texas extrapolated sales are $150k and the NAICS721 contribution in the national volume is 9%, representing a standard deviation from the las twelve months contribution of 0.005. Thus, the stratum of NAICS721 in Texas in April 2023 violates an anonymity rule and contributes ˜33% ($50k/$150k) to the Texas state volume, so it is flagged for capping by the anonymity rules engine 125. In this example, the anonymity rules engine 125 may cap the stratum of NAICS721 in Texas in April 2023 according to Expression 3 such that the corrected sales equals $150k*(9%+2*0.005)=$150k*0.1=$15k. In this example, the report 130 may include the corrected data point of $15k for the stratum of NAICS721 in Texas in April 2023, which contributes 10% to the state volume instead of 33%. In this way, the overall Texas data point is more stable and is less affected by unexpected changes from big contributors within the state.

The analysis engine 120 may include an adjustment ratio engine 126. The adjustment ratio engine 126 may adjust the merchant data based on a corresponding adjustment ratio. In some implementations, the adjustment ratio engine 126 adjusts raw sales figures based on a corresponding ratio between card sales and cash or check sales. In an example, the card/cash ratio may be determined using merchant data including both card and cash (cash and check) sales, which card/cash ratio may be applied to merchant data including only card sales. In this way, card sales can be extrapolated to include unknown cash or check sales based on the card/cash ratio. The card/cash ratio can be national, state-specific, NAICS code-specific, and/or stratum specific. In an example, each region—NAICS code stratum has its own card/cash ratio.

In some implementations, the total revenue can be calculated using Expression 4:

$$Total {Revenue}_{t} = {\sum }_{s = 1}^{S} ( {N}_{s} * \frac{{\sum }_{i = 1}^{{n}_{s}} Card {Revenue}_{i s t}}{{n}_{s} {PctCard}_{s t}} \qquad Expression 4$$

In Expression 4, Total Revenueₛₜ corresponds to the total revenue across all strata, PctCardₛₜ corresponds to the percentage of revenue that is card sales (i.e., the card/cash ratio), the Card Revenueᵢₛₜ corresponds to the card revenue for a stratum, N corresponds to a total number of strata, and nₛ corresponds to a population of strata having the card/cash ratio.

In an example, if 90% of revenue is from card sales in a stratum and raw sales for a month are $1,000, the adjustment ratio engine 126 adjusts the raw sales to be $1,111 to account for the cash and check sales not accounted for in the $1,000.

The analysis engine 120 may include an extrapolation engine 127. The extrapolation engine 127 may extrapolate merchant data to represent all merchants in a region, such as a state or country. In an example, the merchant data may represent a subset of merchants in a state and the extrapolation engine 127 may use census data for the state to extrapolate from the merchant data to represent all merchants in the state. In an example, the extrapolation engine 127 takes merchant data for a state with total sales of $500k, determines that the merchant data represents one-fifth of merchants in the state based on census data, and extrapolates the total sales to $2,500,000 to represent all merchants in the state. In an example, the extrapolation engine 127 takes merchant data for grocery stores in a state, determines the number of grocery stores in the state based on census data, and extrapolates the merchant data for grocery stores in the state to represent all grocery stores in the state.

In some implementations, the extrapolation engine 127 adjusts the census data to be more accurate based on growth rates. In an example, the extrapolation engine 127 adjusts the total number of merchants monthly based on the total number of merchants in the census data and the monthly growth rate of the merchants in the census data. In some implementations, the extrapolation engine 127 adjusts the extrapolated data to remove regular variation related to weekdays, holidays, and other seasonal effects. In an example, the extrapolation engine 127 adjusts the extrapolated data using a seasonal adjustment method used in generating census data to maintain consistency with the census data methodology.

The analysis engine 120 may include an index engine 128. The index engine 128 may calculate an index (also referred to as an index value) for each stratum based on the merchant data. The index engine 128 may calculate the index for each stratum once the merchant data has been aggregated, filtered, anonymized, adjusted, and/or extrapolated, as discussed herein. The index engine 128 may calculate an index to represent a change over time relative to a base period value. In an example, the index may be number showing percentage changes from a base period value represented as “100,” such that the distance of the index from “100” corresponds to percentage changes from the base period value. In an example, an index of “107” corresponds to a seven-percent increase over the base period value. In an example, the index may be based on merchant revenue in the year 2019. The index engine 128 may calculate index values for each stratum. In an example, the index engine 128 may generate index values for small business sales for the U.S., for each NAICS code, for each state, and for each NAICS code within each state. The index engine 128 may calculate index values for different NAICS groupings. In an example, the index engine 128 may calculate index values for 6-digit NAICS codes, 5-digit NAICS codes, 4-digit NAICS codes, 3-digit NAICS codes 2-digit NAICS codes, and/or 1-digit NAICS codes.

In some implementations, the index values are calculated based on merchant sale revenue. In some implementations, the index values are calculated based on merchant sale volume. The index values may be calculated based on any characteristic of the merchant data.

The analysis engine 120 may include an outlier engine 129. The outlier engine 129 may perform outlier operations on each calculated index value to identify outliers. The outlier engine 129 may compare each index values to other index values in a same group to identify the outliers. In an example, the outlier engine 129 may analyze index values within the groups of 3-digit NAICS codes within a state and 2-digit NAICS codes within a state. Different groups of index values may be selected for outlier analysis. In an example, NAICS codes “31-33” may be treated as a single group for outlier analysis.

The outlier engine 129 may calculate a mean and standard deviation for each group of index values. In an example, the outlier engine 129 calculates the mean and standard deviation for each group of index values for the past twelve months. The outlier engine 129 may determine upper and lower bounds, outside of which index values are considered outliers. In an example, the outlier engine 129 determines the upper and lower bounds as six standard deviations above the mean and six standard deviations below the mean, respectively. The outlier engine 129 may cap outliers at the upper and lower bounds.

The analysis engine 120 may generate the report 130 to include the calculated index values. As discussed herein, the report 130 may include nullified, adjusted, or marked index values based on adjustments or corrections to the merchant data or the index values by the analysis engine 120. The report 130 may show the index values over time. In an example, the report 130 may show index values from the baseline period to the present.

In some implementations, the analysis engine 120 may validate the index values against external data. In an example, the index values are validated against third-party or government data. The analysis engine 120 may be updated based on comparing the index values against the third-party or government data.

In some implementations, the analysis engine 120 may include one or more machine learning models. The machine-learning models may be trained using historical merchant data and analysis to provide index values and/or explanations of index values. In some implementations, the selection engine 121 utilizes a machine learning model to select merchants which are US merchants and/or small business merchants. In some implementations, the categorization engine 122 utilizes a machine-learning model to categorize merchants using NAICS codes. In an example, the categorization engine 122 utilizes a machine-learning model to categorize merchants based on a variety of characteristics, including merchant MCC codes. In some implementations, the aggregation engine 123 utilizes a machine learning model to aggregate multiple merchant identifiers under a single merchant. In an example, the aggregation engine 123 determines a probability that multiple merchant identifiers correspond to a single merchant to aggregate the multiple merchant identifiers under the single merchant. In some implementations, the filtering engine 124 utilizes a machine learning model to filter merchants based on characteristics of the merchants. In an example, the filtering engine 124 determines a probability that a merchant is a test account or a ramp-up merchant to filter the merchant. In some implementations, the anonymity rules engine 125 utilizes a machine learning model to determine whether strata violate the anonymity rules. In an example, the anonymity rules engine 125 utilizes a machine learning model to determine a probability that a stratum violates one or more of the anonymity rules. In some implementations, the adjustment ratio engine 126 utilizes a machine learning model to determine the adjustment ratio and/or apply the adjustment ratio to the strata. In some implementations, the extrapolation engine 127 utilizes a machine learning model to determine the number of establishments in a stratum and/or to extrapolate adjusted merchant data to determine the extrapolated data. In some implementations, the index engine 128 utilizes a machine learning model to calculate the index values. In some implementations, the outlier engine 129 utilizes a machine learning model to identify and/or correct outliers. In an example, the outlier engine 129 utilizes a machine learning model to identify a method to identify outliers and to cap the identified outliers.

The system 100 can include a forecast machine learning model 140. The forecast machine learning model 140 can be executed using as input the index values to generate an economic forecast data structure including forecasted economic data. The economic forecast data structure can be a JSON file, a PDF, a table, a CSV, a spreadsheet, a text document, or any type of data structure. The forecasted economic data can include monthly trade survey values, personal consumption statistics, inflation rates, inflation-adjusted index values, government statistics, and other economic data. The forecasted economic data can include data for multiple different aggregation levels such as city-level forecasts, county-level forecasts, state-level forecasts, region-level forecasts, and nation-level forecasts. The forecast machine learning model 140 can generate the economic forecast data structure with forecasted economic data for any time period, using index values from any time period. In an example, the forecast machine learning model 140 generates the economic forecast data structure to include forecasted economic data for a date three months in the future based on index values for the past six months. In an example, the forecast machine learning model 140 generates the economic forecast data structure to include forecasted economic data for a date one month in the future based on index values for the past year. In an example, the forecast machine learning model 140 generates the economic forecast data structure to include forecasted economic data for a date one year in the future based on a current index value.

The forecast machine learning model 140 can be a neural network, a support vector machine (SVM), a decision tree, an ensemble tree, a generalized additive model (GAM), a generative AI model, a transformer model, a generative transformer model, or another type of machine learning model. In an example, the forecast machine learning model 140 is a neural network that is trained to generate economic forecast data structures.

The forecast machine learning model 140 can be trained using supervised training. The forecast machine learning model 140 can be trained using multiple stages of training. Training the forecast machine learning model 140 can include creating a first training set including first index values generated by the analysis engine 120 and economic data such as census statistics or other government statistics. The forecast machine learning model 140 can be trained (e.g., parameters and/or weights updated) in a first stage of training using the first training set. The forecast machine learning model 140 can be trained to receive as input index values to generate forecasted economic data. In an example, the forecast machine learning model 140 is trained to receive as input past and current index values to predict future government statistics (e.g., inflation data, consumer spending, etc.). After the first stage of training, the forecast machine learning model 140 can be executed using as input a second set of index values to generate an economic data forecast data structure including forecasted economic data. A loss is calculated using a difference between the forecasted economic data and measured economic data. In an example, the first set of index values include index values from the years 2017-2019 and the second set of index values include index values from the years 2022 and 2023, where the loss is an absolute mean difference between the predicted economic data for the years 2022 and 2023 and the actual economic data for the years 2022 and 2023.

A subset of the forecasted economic data can be selected based on the calculated loss. In some implementations, the subset of the forecasted economic data is selected based on the calculated loss being above a predetermined threshold (e.g., the subset of the forecasted economic data is inaccurate above an inaccuracy threshold). In this way, inaccurate predictions of economic data generated by the forecast machine learning model 140 are identified to improve subsequent predictions generated by the forecast machine learning model 140. A second training set can be created for a second stage of training the forecast machine learning model 140 including the first training set and the subset of the forecasted economic data selected based on the calculated loss. The forecast machine learning model 140 can be training in a second stage of training using the second training set to increase an accuracy of the forecast machine learning model 140. In this way, the forecast machine learning model 140 is able to learn from its inaccurate predictions to reduce an inaccuracy of future predictions.

In some implementations, the forecast machine learning model 140 is trained in multiple training stages until an accuracy of the forecast machine learning model 140 is above a predetermined threshold. In some implementations, the forecast machine learning model 140 is trained until the calculated loss is below a predetermined threshold. In this way, the forecast machine learning model 140 can be iteratively trained until the forecast machine learning model 140 can generate accurate predictions of economic data. In an example, the forecast machine learning model 140 is iteratively trained using historical economic data and historical index values until a loss between forecasted economic data for past time periods generated by the forecast machine learning model 140 and the corresponding actual historical economic data is below a predetermined threshold, at which point the forecast machine learning model 140 is executed using as input historical and/or current index values to generate forecasted economic data for future time periods.

In an example, the forecast machine learning model 140 is trained using economic data and index values from the year 2014, and the forecast machine learning model 140 is executed using as input index values from the year 2014 to generate predicted economic data for the year 2014. A loss is calculated using a difference between the predicted economic data for the year 2014 and the actual economic data for the year 2014. Predicted economic data associated with loss above a threshold is selected as representing inaccurate predicted economic data and is included in a subsequent training set. The forecast machine learning model 140 is further trained using the economic data and index values from the year 2014 as well as the inaccurate predicted economic data which is flagged and/or weighted as being inaccurate. To avoid overfitting the economic data and index values from the year 2014 to the year 2014, the forecast machine learning model 140 is then further trained using a similar process in further training stages using data from the years 2015-2019. After these training stages, the forecast machine learning model 140 is executed using as input current index values and index values from the past six months to predict economic data for a data six months in the future. When the date arrives and actual economic data for the date is available, the predicted economic data is compared to the actual economic data to calculate a loss. If the loss is below a loss threshold, the training of the forecast machine learning model 140 is complete. If the loss is above the loss threshold, the training of the forecast machine learning model 140 continues. In this example, the training of the forecast machine learning model 140 can be continued even if the loss is below the loss threshold in order to continually or periodically update the forecast machine learning model 140 based on new data.

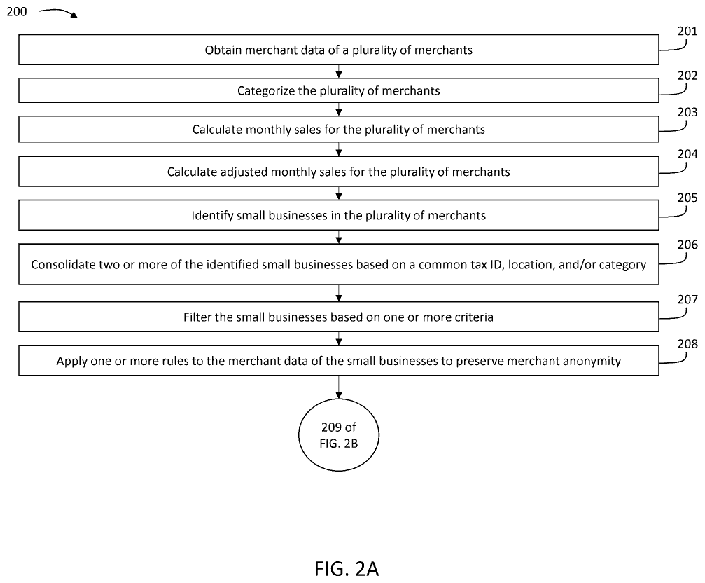

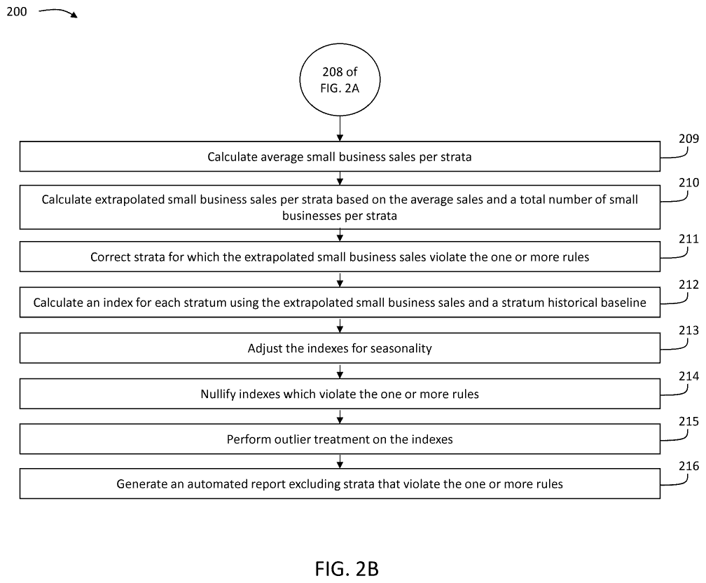

FIGS. 2A and 2B are example flow diagrams illustrating a method 200 for generating a report including an index. The method 200 may include more or fewer operations than shown. The operations may be performed in the order shown, in a different order, or concurrently. The method 200 may be performed by the analysis engine 120 of FIG. 1, and particularly by one or more processors associated with the analysis engine 120. The one or more processors may execute computer-readable instructions stored on a computer-readable medium to perform the method 200.

At operation 201, merchant data of a plurality of merchants is obtained. The merchant data may include transactions, revenue, volume, merchant identifiers, merchant location, merchant tax IDs, merchant type, merchant MCCs, merchant card networks, and other data.

At operation 202, the plurality of merchants are categorized. The plurality of merchants may be categorized based on a predetermined mapping of merchant MCCs to NAICS codes.

At operation 203, monthly sales for the plurality of merchants are calculated based on the merchant data. At operation 204, adjusted monthly sales for the plurality of merchants are calculated based on the calculated monthly sales. The adjusted monthly sales may be calculated based on a card/cash ratio, as discussed herein. The adjusted monthly sales may be calculated based on multiple card/cash ratios for different regions and/or different types of merchants, as discussed herein. In an example, grocery stores in southern California have a card/cash ratio which is used to calculate adjusted monthly sales for grocery stores in southern California.

At operation 205, small businesses are identified in the plurality of merchants. The small businesses may be identified based on the adjusted monthly sales. The small businesses may be identified based on predetermined criteria for small businesses. At operation 206, two or more of the identified small businesses are consolidated based on a common tax ID, location, and/or category. In this way, small businesses with multiple merchant IDs (causing them to be represented twice in the merchant data) may be accurately represented in the merchant data.

At operation 207, the small businesses may be filtered based on one or more criteria. In some implementations, the small businesses may be filtered based on the adjusted monthly sales. In an example, the small businesses may be filtered to remove test accounts, or small businesses that do not have more than nominal sales. In an example, the small businesses may be filtered to remove ramp-up businesses, or businesses whose sales are just starting and which do not accurately reflect a stable condition of those businesses. At operation 208, one or more rules are applied to the merchant data of the small businesses to preserve merchant anonymity. In some implementations, the one or more rules are applied to the adjusted monthly sales of the small businesses to ensure that data points based on the adjusted monthly sales do not provide information about the monthly sales of any specific merchant. The one or more rules may include anonymity rules as discussed herein: the 5/25 rule that each stratum includes at least five merchants with no one merchant contributing more than 25% to a data point associated with the stratum, the PSI rule that a PSI of a stratum does not exceed a PSI threshold, the null values rule that a stratum does not include null historical values, and the minimum population size that a stratum must include a sufficiently large population corresponding to a predetermined confidence interval.

At operation 209, average small business sales per stratum are calculated. In some implementations, the average small business sales may be calculated for those strata which do not violate the anonymity rules. In some implementations, the average small business sales may be calculated for all strata and later corrected for strata which violate the anonymity rules. The average small business sales may be calculated based on the adjusted monthly sales of the small businesses. At operation 210, extrapolated small business sales are calculated per stratum based on the average small business sales and a total number of small businesses per stratum. The total number of small businesses per stratum may be determined using census data. In an example, if the average small business sales for the stratum of NAICS code 3472 in Illinois are $2k and there are 100 small businesses for the stratum of NAICS code 3472 in Illinois, then the extrapolated small business sales for the stratum of NAICS code 3472 in Illinois are $200k. In this way, the extrapolated small business sales account for small businesses in each stratum that are not represented in the merchant data.

At operation 211, the strata are corrected for which the extrapolated small business sales violate the one or more rules. In some implementations, the strata are corrected to adjust the extrapolated small business sales. In some implementations, the strata are corrected to nullify the extrapolated small business sales. In some implementations, the one or more rules are applied to the extrapolated small business sales to correct the extrapolated small business sales. In some implementations, the one or more rules are applied to the adjusted small business sales to correct the extrapolated small business sales.

At operation 212, an index is calculated for each stratum using the extrapolated small business sales and a stratum historical baseline. The index may represent a percent change from the historical baseline. In an example, the index may be a three-digit number which represents a percent change from average monthly sales in 2019. At operation 213, the index values are adjusted for seasonality. The index values may be adjusted for seasonality to remove variation due to months, seasons, or other calendar effects. In an example, the index values are adjusted for seasonality using methods used to adjust census data for seasonality.

At operation 214, index values which violate the one or more rules are nullified. The index values may violate the one or more rules based on the adjusted sales or extrapolated sales from which the index values are calculated violating the one or more rules. Nullifying the index values may include replacing the index values with null values, removing the index values, or otherwise marking the index values as violating the one or more rules. At operation 215, outlier treatment is performed on the index values. The outlier treatment may include comparing index values to other index values in a same group to identify the outliers. In an example, the outlier treatment includes analyzing index values within the groups of 3-digit NAICS codes within a state and 2-digit NAICS codes within a state. Different groups of index values may be selected for outlier treatment. In an example, NAICS codes “31-33” may be treated as a single group for outlier treatment. The outlier treatment may include calculating a mean and standard deviation for each group of index values. In an example, the mean and standard deviation for each group of index values are calculated for the past twelve months. Upper and lower bounds may be determined, outside of which index values are considered outliers. In an example, the upper and lower bounds are six standard deviations above the mean and six standard deviations below the mean, respectively. The outlier treatment may include capping outliers at the upper and lower bounds.

At operation 216, an automated report is generated, the report excluding strata that violate the one or more rules. The report may show the current index for a stratum as well as historical index values for the stratum. In an example, the report includes index values of a stratum for each month from January 2019 to the current month. In this way, the report may analyze a trend based on the index value by identifying a trend within the index values over time.

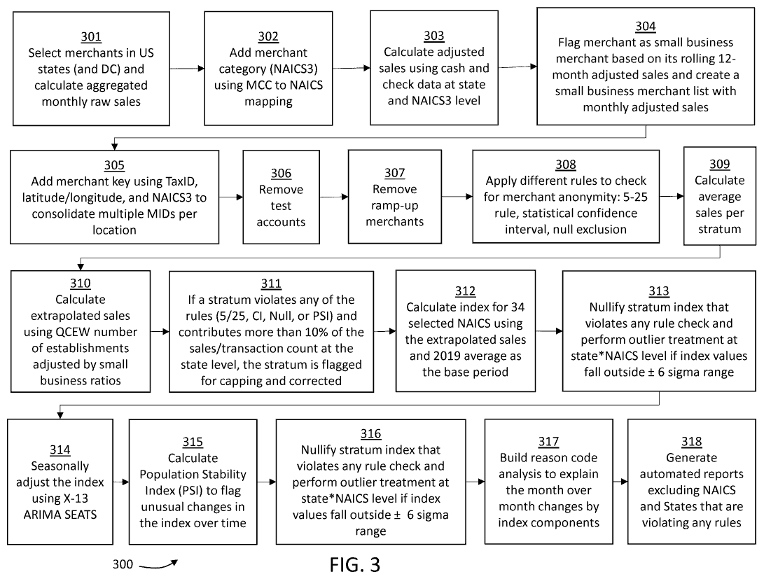

FIG. 3 is an example flow diagram illustrating an example method 300 for generating a report including an index. The example method 300 may include more or fewer operations than shown. The operations may be performed in the order shown, in a different order, or concurrently. The method 300 may be performed by the analysis engine 120 of FIG. 1 and particularly by one or more processors associated with the analysis engine 120. The one or more processors may execute computer-readable instructions stored on a computer-readable medium to perform the method 300 . . . . The example method 300 is in no way limiting of the embodiments discussed herein.

At operation 301, merchants in the US states and District of Columbia are selected from a plurality of merchants in merchant data. Aggregated monthly raw sales for the selected merchants are calculated for the selected merchants based on the merchant data.

At operation 302, merchant categories in the form of 3-digit NAICS codes are added to the selected merchants using an MCC to NAICS mapping. The MCC codes are included in the merchant data, where each merchant is associated with at least one MCC code.

At operation 303, adjusted sales are calculated for the selected merchants using cash and check data at the state and 3-digit NAICS code level. The cash and check data includes a card/cash ratio representing a proportion of sales for each grouping of merchants in each state belonging to each 3-digit NAICS code which are card sales and which are cash or check sales. In an example, merchants in the 3-digit NAICS code category of 371 in the state of Virginia have a card/cash ratio of 89%, meaning that 89% of sales are card sales and 11% of sales are cash or check sales. The card/cash ratio is used to adjust the monthly raw sales to account for cash or check sales not accounted for in the merchant data for merchants who report only card sales in the merchant data.

At operation 304, merchants are flagged as small business merchants based on their rolling 12-month adjusted sales. Merchants are flagged as small business merchants based on small business criteria determined by the Small Business Administration (SBA). A small business merchant list is created with the monthly adjusted sales of the small business merchants.

At operation 305, merchant keys are added to the small business merchant list using Tax IDs, latitude and longitude, and 3-digit NAICS codes of the small business merchants. The merchant keys may be added to the small business merchant list to consolidate multiple merchant IDs (MIDs) in the small business merchant list in a single location under a single merchant key. In this way, merchants that appear to be different merchants in the small business merchant list but which are actually the same merchant are correctly aggregated in the small business merchant list under common merchant keys.

At operation 306, test accounts are removed from the small business merchant list. Test accounts are accounts that have lower monthly sales than a predetermined threshold, such as $20. Test accounts may be created for testing purposes. At operation 307, ramp-up merchants are removed. Ramp-up merchants are merchants that have sales that are increasing or ramping up and which do not have stable sales numbers. Removing test accounts and ramp-up merchants stabilizes the calculation of average monthly sales for the small business merchants.

At operation 308, different rules are applied to check for merchant anonymity. The rules include the 5-25 rule which requires that each stratum includes at least five merchants and that no single merchant accounts for more than 25% of the sales of the stratum, the statistical confidence interval rule which requires that each stratum has a minimum population size to provide a predetermined confidence interval, such as 90%, and the null exclusion rule which requires that a stratum does not have missing historical values.

At operation 309, average sales per stratum are calculated. The strata include 3-digit NAICS codes at the national level as well as 3-digit NAICS codes at the state level. An example of a stratum is the 3-digit NAICS code 372 at the national level. Another example of a stratum is the 3-digit NAICS code 372 in the state of Oregon.

At operation 310, extrapolated sales are calculated using the Quarterly Census of Employment and Wages (QCEW) count of employment and wages. A number of establishments per stratum are determined using the QCEW data, as adjusted by small business ratios. The extrapolated sales are calculated by multiplying the average sales per stratum by the number of establishments in the stratum. In an example, the stratum of the 3-digit NAICS code 417 in the state of Utah is determined to have 100 establishments, of which 25% percent are small businesses such that the small business merchants stratum of the 3-digit NAICS code 417 in the state of Utah is determined to have 25 establishments. In this example, the average monthly sales for the small business merchants stratum of the 3-digit NAICS code 417 in the state of Utah is $10k, meaning that the extrapolated monthly sales total $250k.

At operation 311, if a stratum violates any of the rules applied in operation 308, and contributes more than 10% of the sales or transaction count at the state level, the stratum is flagged for capping and corrected. If a stratum represents more than 10% of a state's total small business sales, the stratum is capped and corrected to reduce the extrapolated sales of the stratum.

At operation 312, index values are calculated for thirty-four 3-digit NAICS codes at the national and state level using the extrapolated sales and average sales of the year 2019 as a base period. The index values are three-digit values representing percentage changes from the base period.

At operation 313, the strata index values that violate the rules applied in operation 308 are nullified. At operation 313, outlier treatment is performed for strata of 3-digit NAICS codes within states. The outlier treatment caps outlier index values within six standard deviations of the average index value of the stratum over the last twelve months.

At operation 314, the index values are adjusted for seasonality using the X-13 ARIMA SEATS program used by the US Census Bureau. In this way, the index values are adjusted for seasonality consistent with the treatment of similar data by the US Census Bureau, allowing for ease of comparison.

At operation 315, a PSI is calculated for each stratum to flag unusual changes in the index over time. The PSI for each stratum is compared against a PSI threshold to determine whether the index is an accurate representation of the stratum or whether additional analysis is required.

At operation 316, index values are nullified for strata which violate the rules applied in operation 308 and/or which exceed the PSI threshold. At operation 216, outlier treatment is performed for strata of 3-digit NAICS codes within states. The outlier treatment caps outlier index values within six standard deviations of the average index value of the stratum over the last twelve months.

At operation 317, a reason code analysis is built to explain the month over month changes by index components. The reason code analysis may be automatically built by a large language model (LLM). The reason code analysis may analyze trends in the index values over time.

At operation 318, automated reports are generated which exclude index values for 3-digit NAICS codes and states that violate rules, such as the rules applied in operation 308 and the PSI threshold applied in operation 315. The automated reports analyze trends in the index values over time.

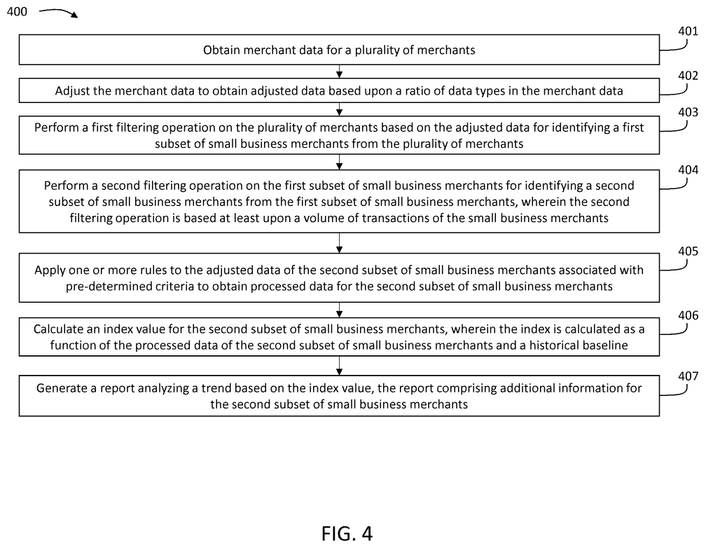

FIG. 4 is an example flow diagram illustrating a method 400 for generating a small business index report. The example method 400 may include more or fewer operations than shown. The operations may be performed in the order shown, in a different order, or concurrently. The method 400 may be performed by the analysis engine 120 of FIG. 1, and particularly by one or more processors associated with the analysis engine 120. The one or more processors may execute computer-readable instructions stored on a computer-readable medium to perform the method 400.

At operation 401, merchant data is obtained for a plurality of merchants. The merchant data may include merchant names, locations, merchant identifiers, tax IDs, sales, sales volume, revenue, and other merchant data. The plurality of merchants may be a subset of merchants in a geographic area. In an example, the plurality of merchants are a subset of US merchants.

At operation 402, the merchant data is adjusted to obtain adjusted data based upon a ratio of data types in the merchant data. In some implementations, the ratio of data types in the merchant data is a ratio of cash transactions and card transactions. In some implementations, the ratio of cash transactions and card transactions is calculated based on a subset of the merchant data including cash transactions and card transactions. In this way, merchant data for merchants with only card transactions can be adjusted to account for cash and/or check transactions not represented in the merchant data.

At operation 403, a first filtering operation is performed on the plurality of merchants based on the adjusted data for identifying a first subset of small business merchants from the plurality of merchants. The first filtering operation may include excluding merchants with monthly sales and/or annual sales above a predetermined threshold.

At operation 404, a second filtering operation is performed on the first subset of small business merchants for identifying a second subset of small business merchants from the first subset of small business merchants, where the second filtering operation is based at least upon a volume of transactions of the small business merchants. The second filtering operation may include excluding merchants with monthly and/or annual sales below a predetermined threshold and/or merchants with monthly and/or annual sales with rates of change beyond predetermined thresholds.

At operation 405, one or more rules are applied to the adjusted data of the second subset of small associated with pre-determined criteria to obtain processed data for the second subset of small business merchants. In some implementations, applying the one or more rules to the adjusted data of the second subset of small business merchants may include determining a proportion of total sales contributed by each merchant of the second subset of small business merchants. In some implementations, applying the one or more rules to the adjusted data of the second subset of small business merchants may include adjusting the index or removing the index from the report prior to publishing a report.

At operation 406, an index value is calculated for the second subset of small business merchants, wherein the index is calculated as a function of the processed data of the second subset of small business merchants and a historical baseline. In some implementations, calculating the index may include extrapolating a total revenue for a category of merchants based on the processed data of the second subset of small business merchants and a total number of merchants in the category of merchants. The total number of merchants may be determined based on census data.

At operation 407, a report is generated analyzing a trend based on the index value, the report comprising additional information for the second subset of small business merchants.

In some implementations, the method 400 includes categorizing the merchant data based on a pre-configured mapping of merchant identifiers associated with the plurality of merchants to a set of standardized merchant categories. In an example, the set of standardized merchant categories are NAICS codes and the merchant identifiers are mapped to the NAICS codes based on MCCs associated with the merchant identifiers.

In some implementations, the method 400 includes identifying a single merchant of the plurality of merchants, the single merchant associated with multiple merchant identifiers and aggregating the data associated with the multiple merchant identifiers under the single merchant based on one or more of a shared location, a shared tax identifier, or a shared merchant category associated with the multiple merchant identifiers.

In some implementations, the method 400 includes determining that the calculated index is an outlier and adjusting the calculated index based on the calculated index being an outlier. In some implementations, determining that the calculated index is an outlier includes determining that the calculated index is outside of a predetermined number of standard deviations from a historical average of the calculated index.

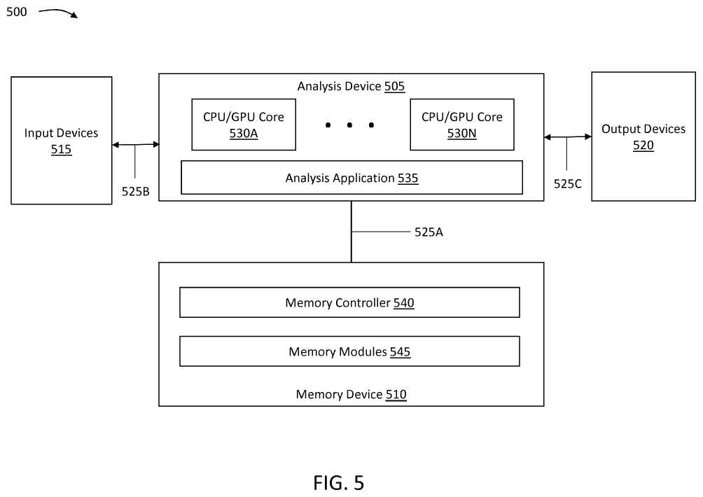

FIG. 5 is an example block diagram of a computing system 500, in accordance with some embodiments of the present disclosure. The computing system 500 includes a host device 505 associated with a memory device 510. The host device 505 may be configured to receive input from one or more input devices 515 and provide output to one or more output devices 520. The host device 505 may be configured to communicate with the memory device 510, the input devices 515, and the output devices 520 via appropriate interfaces or channels 525A, 525B, and 525C, respectively. The computing system 500 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 505.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 500) may be implemented by multiple computing devices in a distributed environment, and vice versa.

The input devices 515 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 505 and that allows an external source, such as a user, computer, or database, to enter information (e.g., data) into the host device and send instructions to the host device 505. Similarly, the output devices 520 may include a variety of output technologies such as external memories, databases, printers, speakers, displays, microphones, light emitting diodes, headphones, plotters, speech generating devices, video devices, and any other output peripherals that are configured to receive information (e.g., data) from the host device 505. The “data” that is either input into the host device 505 and/or output from the host device may include any of a variety of textual data, graphical data, video data, sound data, position data, combinations thereof, or other types of analog and/or digital data that is suitable for processing using the computing system 500.

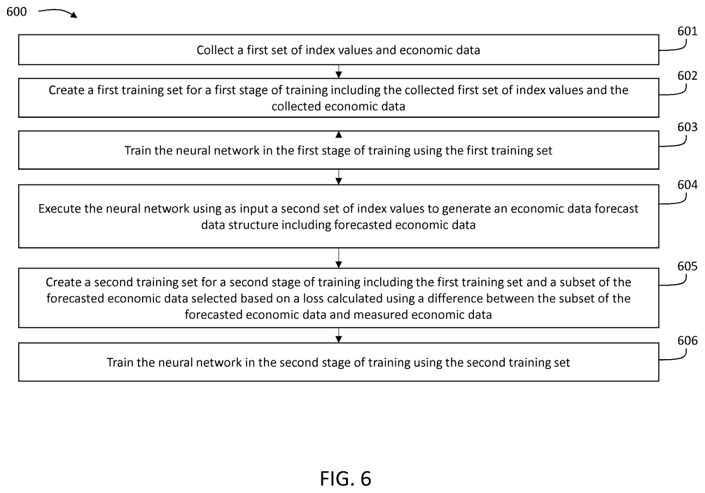

The host device 505 may include one or more Central Processing Unit (“CPU”) or Graphics Processing Unit (“GPU”) cores or processors 530A-530N that may be configured to execute instructions for running one or more applications associated with the host device 505. In some embodiments, the instructions and data needed to run the one or more applications may be stored within the memory device 510. The host device 505 may also be configured to store the results of running the one or more applications within the memory device 510. One such application on the host device 505 may include an analysis application 535. The analysis application 535 may be executed by one or more of the CPU/GPU cores 530A-530N. The instructions to execute the analysis application 535 may be stored within the memory device 510. The analysis application 535 is described in greater detail above and may perform functions such as the method 200 of FIGS. 2A and 2B, the method 300 of FIG. 3, the method 400 of FIG. 4, and the method 600 of FIG. 6. Thus, the host device 505 may be configured to request the memory device 510 to perform a variety of operations. For example, the host device 505 may request the memory device 510 to read data, write data, update or delete data, and/or perform management or other operations.

To facilitate communication with the memory device 510, the memory device 510 may include or be associated with a memory controller 540. Although the memory controller 540 is shown as being part of the memory device 510, in some embodiments, the memory controller 540 may instead be part of the host device 505 or another element of the computing system 500 and operatively associated with the memory device 510. The memory controller 540 may be configured as a logical block or circuitry that receives instructions from the host device 505 and performs operations in accordance with those instructions. For example, when the execution of the analysis application 535 is desired, the host device 505 may send a request to the memory controller 540. The memory controller 540 may read the instructions associated with the analysis application 535 that are stored within the memory device 510, and send those instructions back to the host device. In some embodiments, those instructions may be temporarily stored within a memory on the host device 505. One or more of the CPU/GPU cores 530A-530N may then execute those instructions by performing one or more operations called for by those instructions of the analysis application 535.

The memory device 510 may include one or more memory circuits 545 that store data and instructions. The memory circuits 545 may be any of a variety of memory types, including a variety of volatile memories, non-volatile memories, or a combination thereof. For example, in some embodiments, one or more of the memory circuits 545 or portions thereof may include NAND flash memory cores. In other embodiments, one or more of the memory circuits 545 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 510. In some embodiments, one or more of the memory circuits 545 or portions thereof may be configured as other types of storage class memory (“SCM”). Generally speaking, the memory circuits 545 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 500 are shown and described in FIG. 5. However, the computing system 500 may include other components such as various batteries and power sources, networking interfaces, routers, switches, external memory systems, controllers, etc. Generally speaking, the computing system 500 may include any of a variety of hardware, software, and/or firmware components that are needed or considered desirable in performing the functions described herein. Similarly, the host device 505, the input devices 515, the output devices 520, and the memory device 510, including the memory controller 540 and the memory circuits 545, may include hardware, software, and/or firmware components that are considered necessary or desirable in performing the functions described herein. In addition, in certain embodiments, the memory device 510 may integrate some or all of the components of the host device 505, including, for example, the CPU/GPU cores 530A-530N, and the CPU/GPU cores may be configured to execute the analysis application 535, as described herein.

FIG. 6 is an example flow diagram illustrating a method 600 for training a neural network to generate economic forecast data structures. The method 600 may include more or fewer operations than shown. The operations may be performed in the order shown, in a different order, or concurrently. One or more processors may execute computer-readable instructions stored on a computer-readable medium to perform the method 600. The method 600 may be used to train the forecast machine learning model 140 of FIG. 1. In some implementations, the method 600 is performed by the computing system 500 of FIG. 5.

At operation 601, a first set of index values and economic data are collected. The first set of index values can be generated by the analysis model 120 of FIG. 1. The economic data can include government statistics such as census statistics, inflation statistics, job statistics, consumer consumption statistics, and other statistics.

At operation 602, a first training set for a first stage of training is created including the collected first set of index values and economic data. The first training set can include labels and/or weights indication information for training the neural network. In an example, weights can be applied to the economic data to indicate an importance or confidence in the economic data.

At operation 603, the neural network is trained in the first stage of training using the first training set. Training the neural network can include modifying parameters of the neural network. In some implementations, training the neural network includes executing the neural network using as input the first set of index values to predict the economic data and using a reward function to modify the parameters of the neural network based on a similarity between the predicted economic data and the economic data. In some implementations, training the neural network includes executing the neural network using as input the first set of index values to predict the economic data and using a loss function to modify the parameters of the neural network based on a difference between the predicted economic data and the economic data.

At operation 604, the neural network is executed using as input a second set of index values to generate an economic data forecast data structure including forecasted economic data. The economic data forecast data structure can be any data structure such as a JSON file, a PDF, a CSV, a table, a spreadsheet, or text document. In some implementations, the second set of index values is the same as the first set of index values. In some implementations, the second set of index values is distinct from the first set of index values, but for a same or similar region (e.g., same city or state, different time periods).

At operation 605, a second training set is created including the first training set and a subset of the forecasted economic data selected based on a loss calculated using a difference between the subset of the forecasted economic data and measured economic data. The subset can be selected based on the loss to allow the neural network to learn from its mistakes, or from its inaccurate predictions.

At operation 606, the neural network is trained in a second stage of training using the second training set. The neural network is trained in the second stage to cause the neural network to learn from its inaccurate predictions to improve an accuracy of future predictions.

In some implementations, the method 600 includes training the neural network in subsequent stages of training until a loss calculated using a difference between subsequent forecasted economic data and the measured economic data is below a predetermined threshold. In some implementations, the method 600 includes further training the neural network on additional data to prevent overfitting of the neural network to particular training data.

### Non-Limiting Examples

The index may be a growth index or indicative of other parameters. The index is a 3-digit score that provides a wide representation of how businesses (e.g., small business) may be performing. The index may be based on a the definition of a small business based on SBA and aggregated and normalized for government census population statistics. The index may be calculated against a base index of 100 from 2019 with the numbers to allow for an intuitive percent increase over that base measure. Inputs to the index may be merchant revenue aggregated from the credit-card authorizations and cash payments, which will include active businesses along with “birth” of additional businesses and sunset of discontinued business operations. The index can be decomposed and reviewed at industry level and for geographic breakdowns, however the index numbers bear no power to be able to reverse-engineer either business coverage as such or merchants' performance.

The Index uses purpose-built models to normalize anonymized merchant data against official government statistics to reflect the general population of small businesses in the US. This robust methodology expands the ability to delineate between small business merchants for which merchant data is available and the small business community at large more clearly, while also providing a powerful new tool that can be used by policy makers as well as to help small businesses make key decisions.

The Index methodology is robust and stands out from other reports in the market in four ways: (1) focusing exclusively on small businesses, (2) being based on merchant revenue, (3) utilizing cash & check data in addition to credit/debit receipts, and (4) publishing at high frequencies and not being reliant on waiting for publication of government statistics.

Data on small business revenue is crucial for monitoring macroeconomic conditions and the distinct merit of this Index is its unparalleled focus on small businesses that are vital to the current and future health of the economy but often underrepresented in economic data.

In the United States, personal consumption expenditures comprise nearly 70 percent of gross domestic product (GDP) and are therefore a key determinant of the cyclical position of the economy and small businesses play a vital role in that. However, consumption can be hard to measure in practice, particularly in a timely and detailed manner. Existing official statistics on consumer spending are extremely useful but limited.

For instance, retail sales from the Census Bureau's surveys are published for the nation as a whole at a monthly frequency. The monthly figures are available after about two weeks and often revised considerably. The Census statistics also do not include any subnational detail, so for analysis of regional shocks, researchers and policymakers must rely on other data sources, such as the quarterly regional accounts from the Bureau of Economic Analysis (BEA), or household expenditure surveys like the Consumer Expenditure Survey. These data sources have limited sample sizes at smaller geographies and are only available after a lag of a year or two.

Small Business Definition—Merchants are identified as small businesses based on the SBA firm size standard revenue definitions at 6-digit NAICS level. The SBA reviews size standards on an on-going basis to determine whether they need to be adjusted in light of current economic conditions. Federal law also requires the SBA to review receipts-based size standards at least every five years to adjust them for inflation, if necessary.

NAICS 2022—Small business indices are based on NAICS 2022 as used by SBA in their latest release.

Population base—Active MIDS: Merchant who has a transaction activity in the month is considered active for that month

Exclude test Accounts—Accounts that have less than $20 sales in each of the last 12 months. Corresponding Merchant IDs are flagged as test accounts and are excluded from population base.

Multiple MIDS per location—MIDs are aggregated to a single merchant key if they belong to same NAICS, Tax ID and same latitude/longitude (up to 6 decimal). The final index will be calculated based on average revenue sales per merchant key instead of each MID.

Adjustment for Cash and Check—Ideally, the index should reflect total revenue including cash and check rather than just revenue from card sales. The challenge is that not all cash and check transactions are captured and there is limited transaction data available. Using the previous year's transaction data, total payments done by cash, check and card are calculated to get the percentage of payments done by card vs cash and check. Adjustment for cash and check is done on monthly basis using proportion of card transaction calculated annually based on previous year's transactions-all check, cash and card.

Cash Outlier Treatment—Outlier correction is done at NAICS and National level, if any one of the following conditions are satisfied: number of merchants are less than 5, there is no cash utilization, card utilization is less than 50%. Then, the card utilization is replaced by national NAICS averages.

Floor and Ceiling Conditions—Ceiling: Merchants for the index base year 2019 are selected based on criteria annual sales less than equal to SBA size standard revenue threshold definition. Starting January 2020, monthly correction on the small business population is done based on rolling 12-month aggregated (including current month) sale less than equal to SBA size standard threshold definition. Floor: For year 2019, merchants whole annual 2019 sales are less than $1000 are excluded. From year 2020 onwards, only merchants who have more than $20 sales in any month in the past 12 months are included in the population.

Average Sales calculation based on merchant_key—If a merchant_key has 2 active MIDS, then the final averages is calculated on 1 merchant_key rather than 2 MIDS. Final population base-all active merchant_keys. Example: For a strata, CA and NAICS 123, the total sales by all MIDS is $500k and total MIDS are 2k aggregating to 1k merchant_keys, then the average sale for that strata would be: =$500k/1k=$500

Rules Violators Identification—Following Rules are identified: Rule 5/25, PSI (Population Stability Index), CI—Minimum Sample Rule, and Null Rule. All Rules are applied for both Seasonally and Non-Seasonally Adjusted volumes.

Rule 5/25-5/25 rules exclude certain merchants at the state level or NAICS Level. For published analytics we comply with the following for each data point that we include in a data set: contains at least 5 merchants (a merchant can be a single MID or a roll up of many MIDs) and no merchant can contribute more than 25% to the value shown.

PSI (Population Stability Index) Rule—PSI Violation Rules—Will be performed at different strata levels—NAICS3, NAICS2, NAICS2 group, State*NAICS3, State*NAICS2, State*NAICS2 Group. If the MOM PSI is violated, then an additional check on YoY PSI is required. If both MOM and YoY PSI are violated based on threshold >0.2, then the stratum is flagged as a PSI violator. The PSI may be calculated using Expression 1.

Null Rule—There should be no missing monthly values from January 2019 till present for that stratum.

Min Sample Size—Minimum number of merchants for each stratum is determined using the Expression 2 with confidence level of 90% and margin error of 10%. Margin of error relates to the size of sample and tells how close the sample estimation is from population value. If the strata merchant count is less than the min sample size calculated, stratum is flagged for confidence interval-based minimum sample size violation.

Capping for Violators based on State Level Contribution—If the strata violate any of the rules (5/25, CI, Null, or PSI) and contributes to more than 10% of the sales/transaction count at State level, the strata is flagged for capping. Capping is done on the State & NAICS3 level using state sales/transaction count according to Expression 3.

Census Extrapolation—Average small business sales per merchant at strata level are extrapolated to the total number of establishments as released by Bureau of Labor Statistic—Quarterly Census of Employment and Wages. Monthly Adjustment for New Businesses—New businesses are added every day and the index should reflect it. Total number of establishments by Census (Ni) are adjusted monthly for a given State and NAICS using YoY small business growth rate published annually by the SBA: Small Business Economic over CBP published number of establishment in year 2019.

Seasonal Adjustment—To use the index for time-series analysis, it needs to remove regular variation related to weekdays, holidays, and other calendar effects. Seasonal adjustment of the data is done using X-13 ARIMA program as maintained by the Census Bureau. An advantage of this method is that it is also used to seasonally adjust the Census retail sales data, which is used for comparison with the monthly estimates. Seasonal Adjustment is done at strata level (State*NAICS) and rolled up at different levels to get final indices. Example: Seasonal adjusted values for all states and NAICS 445 will be rolled up to get index for NAICS 445.

Null Exclusions—If a strata (state and NAICS) has any null values in the data, the strata is not seasonally adjusted and is not of any aggregated levels like National, NAICS, or state level. Every month, list of strata excluded due to null handling are saved and investigated if the total number of strata exceeds a certain threshold.

Index Calculation—The Index is published as an index number that shows the change in the sales revenue of a defined NAICS over time from a base period (2019), which is defined as 100. An increase of 7 percent from that base period, for example, is shown as 107. Index numbers are not dollar values, but measures of the change over time relative to their base period value of 100.0 (for example, 280.0 or 30.3). Index numbers also are commonly used to measure the size and direction of revenue movements between various time periods such as monthly, quarterly, semiannual, and annual percent changes.

Outlier Treatment—After Index Creation, outlier treatment is done at the below three levels: (1) State and NAICS3, (2) State and NAICS2, (3) State and NAICS2 Grouping. Within the State and NAICS2 Grouping, NAICS 31, 33 are grouped as 31-33, NAICS 44, 45 are grouped as 44-45, and NAICS 48, 49 are grouped as 48-49.

Outlier Criteria—Mean+/−6 Standard Dev to calculate upper and lower bounds for each transaction month: Mean=National NAICS index average of last 12 months, Std Dev=National NAICS index standard deviation of last 12 months, Lower Bound=Mean−6*Std Dev (If the lower bound drops below 0, then we cap it to 0) Upper Bound=Mean+6*Std Dev. If the index value falls below the lower bound, then the index is capped at lower bound. If the index value is greater than upper bound, then the index is capped at upper bound. For example, state WY and NAICS 524 has an index value of 250 in November 2023. NAICS 524 average index from last 12 mons is 160 and standard deviation is 7. Upper limit=160+6*7=202. Lower limit=160-6*7=118. The revised index for WY&524 would be capped at 202, as the actual index value of 250 is out of the range 118-202.

Transaction count-based Index—Additional index is created on transaction volume on same data frame. Cash and universe adjustments are done on transaction count.

Validation-indices are validated against two official publications released on a monthly basis. The first official publication for validation is the Monthly Retail Trade Survey (MRTS) which provides monthly estimates of sales at retail and food services stores and inventories held by retail stores. It is published by the US Census Bureau. Aggregation is done at national and NAICS Code level for 13 NAICS from Retail and Food Services Industry. Monthly Data is released with a lag of 6 weeks. Data published is both seasonally adjusted (SA) and non-seasonal adjusted (NSA). Ecommerce merchants are included. The second official publication for validation is the personal consumption expenditures (PCE). The US Bureau of Economic Analysis publishes the PCE, which is the value of the goods and services purchased by, or on the behalf of, U.S. residents. Monthly Data is released with a lag of 5 weeks. Data is published seasonally adjusted (SA).

MRTS and PCE are not based on small business, but MRTS is 50% based on small business merchants, and PCE has high small business contribution. MRTS is skewed towards urban merchants.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method comprising:
obtaining merchant data for a plurality of merchants;
adjusting the merchant data to obtain adjusted data based upon a ratio of data types in the merchant data;
performing a first filtering operation on the plurality of merchants based on the adjusted data for identifying a first subset of small business merchants from the plurality of merchants;
performing a second filtering operation on the first subset of small business merchants for identifying a second subset of small business merchants from the first subset of small business merchants, wherein the second filtering operation is based at least upon a volume of transactions of the small business merchants;
applying one or more rules to the adjusted data of the second subset of small business merchants associated with a pre-determined criteria to obtain processed data for the second subset of small business merchants;
calculating an index value for the second subset of small business merchants, wherein the index is calculated as a function of the processed data of the second subset of small business merchants and a historical baseline; and
generating a report analyzing a trend based on the index value, the report comprising additional information for the second subset of small business merchants.

2. The method of claim 1, wherein applying the one or more rules to the adjusted data of the second subset of small business merchants comprises determining a proportion of total sales contributed by each merchant of the second subset of small business merchants.

3. The method of claim 1, wherein calculating the index comprises extrapolating a total revenue for a category of merchants based on the processed data of the second subset of small business merchants and a total number of merchants in the category of merchants.

4. The method of claim 3, wherein the total number of merchants is determined based on census data.

5. The method of claim 1, wherein the ratio of data types in the merchant data comprises a ratio of cash transactions and card transactions.

6. The method of claim 5, wherein the ratio of cash transactions and card transactions is calculated based on a subset of the merchant data comprising cash transactions and card transactions.

7. The method of claim 1, wherein applying the one or more rules to the adjusted data of the second subset of small business merchants comprises adjusting the index or removing the index from the report prior to publishing the report.

8. The method of claim 1, further comprising categorizing the merchant data based on a pre-configured mapping of merchant identifiers associated with the plurality of merchants to a set of standardized merchant categories.

9. The method of claim 8, further comprising:
identifying a single merchant of the plurality of merchants, the single merchant associated with multiple merchant identifiers; and
aggregating data associated with the multiple merchant identifiers under the single merchant based on one or more of a shared location, a shared tax identifier, or a shared merchant category associated with the multiple merchant identifiers.

10. A system comprising:
one or more memories having computer-readable instructions stored thereon; and
one or more processors that execute the computer-readable instructions to:
obtain merchant data for a plurality of merchants;
adjust the merchant data to obtain adjusted data based upon a ratio of data types in the merchant data;
perform a first filtering operation on the plurality of merchants based on the adjusted data for identifying a first subset of small business merchants from the plurality of merchants;
perform a second filtering operation on the first subset of small business merchants for identifying a second subset of small business merchants from the first subset of small business merchants, wherein the second filtering operation is based at least upon a volume of transactions of the small business merchants;
apply one or more rules to the adjusted data of the second subset of small business merchants associated with a pre-determined criteria to obtain processed data for the second subset of small business merchants;
calculate an index value for the second subset of small business merchants, wherein the index is calculated as a function of the processed data of the second subset of small business merchants and a historical baseline; and
generate a report analyzing a trend based on the index value, the report comprising additional information for the second subset of small business merchants.

11. The system of claim 10, wherein the one or more processors further execute computer-readable instructions to apply the one or more rules to the adjusted data of the second subset of small business merchants by determining a proportion of total sales contributed by each merchant of the second subset of small business merchants.

12. The system of claim 10, wherein the one or more processors further execute computer-readable instructions to calculate the index by extrapolating a total revenue for a category of merchants based on the processed data of the second subset of small business merchants and a total number of merchants in the category of merchants.

13. The system of claim 12, wherein the total number of merchants is based on census data.

14. The system of claim 10, wherein the ratio of data types in the merchant data comprises a ratio of cash transactions and card transactions.

15. The system of claim 14, wherein the ratio of cash transactions and card transactions is calculated based on a subset of the merchant data comprising cash transactions and card transactions.

16. The system of claim 10, wherein the one or more processors further execute computer-readable instructions to apply the one or more rules to the adjusted data of the second subset of small business merchants by adjusting the index or removing the index from the report prior to publishing the report.

17. The system of claim 10, wherein the one or more processors further execute computer-readable instructions to categorize the merchant data based on a pre-configured mapping of merchant identifiers associated with the plurality of merchants to a set of standardized merchant categories.

18. The system of claim 17, wherein the one or more processors further execute computer-readable instructions to:
identify a single merchant of the plurality of merchants, the single merchant associated with multiple merchant identifiers; and
aggregate the data associated with the multiple merchant identifiers under the single merchant based on one or more of a shared location, a shared tax identifier, or a shared merchant category associated with the multiple merchant identifiers.

19. A computer-implemented method of training a neural network for generating economic forecast data structures comprising:
collecting a first set of index values and economic data;
creating a first training set for a first stage of training comprising the collected first set of index values and the collected economic data;
training the neural network in the first stage of training using the first training set;
executing the neural network using as input a second set of index values to generate an economic data forecast data structure including forecasted economic data;
creating a second training set for a second stage of training comprising the first training set and a subset of the forecasted economic data selected based on a loss calculated using a difference between the subset of the forecasted economic data and measured economic data; and
training the neural network in the second stage of training using the second training set.

20. The computer-implemented method of claim 19, further comprising training the neural network in subsequent stages of training until a loss calculated using a difference between subsequent forecasted economic data and the measured economic data is below a predetermined threshold.
